(19) United States
(12) Patent Application Publication
(10) Pub. No.: US 2001/0036254 A1
(43) Pub. Date: Nov. 1, 2001

(54) DVR Telephone answering device

(76) Inventors: Robert Davis, Woodbine, MD (US); Adrian Yap, Gaithersburg, MD (US); Michael Ficco, Silverspring, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/826,504

(22) Filed: Apr. 5, 2001

Related U.S. Application Data
(60) Provisional application No. 60/199,438, filed on Apr. 25, 2000.

(51) Int. Cl. H04M 1/64

(52) U.S. Cl. 379/67.1

(57) ABSTRACT

A digital telephone answering device DTAD) that utilizes the functionality of a device such as a set top box (STB) equipped with a digital video recorder (DVR). The system includes a DTAD operatively connected to an STB equipped with DVR, or DVR TAD. A memory of the STB equipped with DVR is used by the DVR TAD for storing a plurality of parameters and data such as telephone messages and caller ID signals typically associated with the DVR TAD. A microprocessor within the STB equipped with DVR controls DVR TAD functionality and display of parameters associated with the DVR TAD. Control is based on receiving user commands to access the memory and to display at least a selected one of DVR TAD associated parameters for review and/or manipulation by the viewer or user on a display device operatively connected to the STB equipped with DVR.

### RELATED APPLICATION

This application claims the benefit under 35 U.S.C. Section 119(e) of a U.S. Provisional Patent Application by Adrian Yap et al. entitled “DIGITAL VIDEO RECORDER”, Serial No. 60/199,438, filed on Apr. 25, 2000, the entire contents of which is incorporated by reference herein.

### BACKGROUND OF THE INVENTION

1. Technical Field of the Invention

This invention generally relates to applications and features related to digital recording devices. More particularly, the present invention is directed to a system and/or apparatus composed of a digital telephone answering device (DTAD) connected to or integral with a set top box (STB) equipped with a digital video recorder (DVR).

2. Description of Related Art

Conventional communications systems typically include a receiver for receiving and processing transmitted waveforms. For example, in a satellite communications system, the receiver may include a small satellite dish connected by a cable to a set-top box (STB) or an integrated receiver-decoder (IRD), which are used as interchangeable terms in the art. The satellite dish is aimed toward the satellites, and the STB is connected to the user's television in a similar fashion to a conventional cable-TV decoder.

A micro-controller controls the overall operation of the STB, including the selection of parameters, the set-up and control of components, channel selection, viewer access to different programming packages, blocking certain channels, and many other functions. The compression and decompression of packetized video signals may be accomplished according to the Motion Picture Expert Group (MPEG) standards and the compression and decompression of audio signals may be accomplished according to the Motion Picture Expert Group (MPEG) standards, DOLBY DIGITAL (or AC-3) standards, DTS or other known standards. The conventional STB also typically includes video and audio decoders in order to decompress the received compressed video and audio. The STB may output video and audio data to a number of destinations, including audio and video decoders, ports, memories, and interface devices, such as a digital VHS (DVHS) interface. The STB may send the same audio and video data to different destinations.

Recently, due to the advances in digital technology and with a goal of creating greater personalized television for viewers, the STB has become embodied as part of a digital VCR (DVCR) an/or digital VHS (DVHS) receiver for example, in the continuing development of digital video recording devices. These devices incorporate a host of both traditional and powerful new features. For example, these features may include high quality digital AN, the ability to pause/rewind live video and/or audio programs as they are broadcast, multi-speed fast forward and fast rewind, instant replay, slow motion and frame by frame advance. Additionally, the viewer may have access to, and have the ability to manipulate or develop an electronic program guide of listings.

Such digital video recording devices allow sports fans and movie buffs alike to have full control of live television programs and sporting events in full digital-quality. Viewers may also be able to create customized programming by searching for, and recording, programs that match their preferences by actor, director, keyword or any combination of content searches. Combined with the wide variety of program selections, viewers may find exactly what they are looking for and even create their own “TV channels” based on their favorite programming.

The electronic program guides generally may be displayed as a menu on a screen of a TV for example. Operation of push buttons or keys of a remote control may display a series of menu screens having an array of cells corresponding to particular programming events, channels, TV programs, etc. The viewer may scroll through the cells to choose a particular program, pull up another sub menu to find out more information on a particular program, or pull up a sub menu with additional options.

Most everyone is acquainted with the conventional telephone answering device (TAD). Typically the device is hooked up to a telephone and by means of a magnetic recording medium, records oral messages received from a caller after sending an outgoing message beforehand. However, the conventional TAD is limited as to its storage capacity and is cumbersome to the user when retrieving messages, since often the user must listen to all messages stored thereon and then copy the messages down to obtain a hard copy.

In an effort to overcome some of these problems, digital telephone answering devices (DTAD) have been developed which provide much greater functionality and flexibility to the user than the conventional magnetic tape recording TADs. For example, voice mail DTADs such as that disclosed in U.S. Pat. No. 5,400,393 to Knuth et al. dynamically allocates RAM to store incoming and outgoing messages in particular “mailboxes”, converting analog voice received over a telephone line into digital form.

U. S. Pat. No. 5,343,516 to Callele et al. describe interfaces that can be used to connect a computer to a telecommunications system in order to perform functions that typically might be performed by a DTAD (caller-ID, repeat dial, automatic call back, etc.). Callele et al. also describe the ability to display caller-ID information on a TV screen for example.

U.S. Pat. No. 5,917,892 to Lee describes a recorded telephone message/number identifying apparatus that uses a TV screen in order to display the time at which a caller called with caller-ID (phone number only), and whether or not a voice message was saved. The user may then select a desired recording to hear, the voice message being played back on the TV speaker for example. And U.S. Pat. No. 5,917,892 to Lagoni et al. describe a television receiver that includes telephone network interface circuitry enabling the receiver to receive and process caller-ID signals for display, with messages from priority callers designated to interrupt a viewer's broadcast being displayed at the discretion of the viewer

However, although digital video recording devices and the DTADs described above are known, the combination of these known arts have never been embodied in a digital telephone answering device (DTAD) that is operatively connected to or integral with a set top box (STB) equipped with a digital video recorder (DVR). Accordingly, there is a need for a DTAD that can take advantage of the unlimited storage capacity and plurality of menu driven functions offered by the DVR, providing a TAD with more functionality and flexibility than what is currently available.

### SUMMARY OF THE INVENTION

The present invention is directed to a digital telephone answering device that utilizes the functionality of a device such as a set top box (STB) equipped with a digital video recorder (DVR). The system includes a DTAD operatively connected to or integral with an STB equipped with DVR. A memory within the DVR is used by the DTAD and for storing a plurality of parameters and data typically associated with the DTAD; and a microprocessor within the DVR controls DTAD functionality and display of parameters associated with the DTAD. Control is based on receiving user commands to access the memory and to display at least a selected one of the DTAD associated parameters for review and/or manipulation by the viewer on a display device operatively connected to the STB-equipped with DVR. A suitable interface such as a remote control may be used in order to transmit a command to display desired DTAD parameter(s) or associated data.

Parameters, features, functions and displays related to the operation of the integrated STB-equipped with DVR and DTAD (hereafter DTAD is referred to as “DVR TAD”) include, but are not limited to: a listing of messages received which include a menu display providing the identity of the caller, and a short adjacent text synopsis of the corresponding stored voice message; a “catalog” or “phone book” of stored caller information, which may include name, phone number and other identifying criteria that may be entered by the user; menu features that enable the user to choose between a text display or voice playback of a recorded message; automatic call back features; menu features enabling the user to send a stored voice and/or text message to another person via a medium such as the internet (i.e., transmitting an e-mail message with text file or sound file attached thereto, and other attributes associated with the functionality and operation of the DVR TAD.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exemplary arrangement of a set-top box (STB) and DVR TAD within a direct broadcast satellite or digital video broadcast system in accordance with the invention;

FIG. 2 illustrates a general data flow in a direct broadcast satellite or digital video broadcast system in accordance with the invention;

FIG. 3 is a block diagram of an exemplary architecture of the STB-equipped with DVR and DVR TAD;

FIG. 4 is a block diagram showing an exemplary construction of the graphics accelerator according to the invention;

FIG. 5 illustrates a partial block diagram of FIG. 3 to show the components associated with the DVR TAD portion of the STB equipped with DVR;

FIG. 6 is a flow diagram showing data flow for recording a program, broadcast or event for later playback in accordance with an exemplary embodiment of the invention;

FIGS. 7A and 7B illustrate exemplary answer and record modes for the DVR TAD in accordance with the invention;

FIG. 8 illustrates a general playback flow diagram for a stored voice message in accordance with an exemplary embodiment of the invention;

FIG. 9 illustrates a partial block diagram of FIG. 3 to show an exemplary communication path between a remote control and the host processor of the DVR TAD;

FIG. 10 illustrates the data flow to display a parameter or data of the TAD using the DVR TAD circuitry;

FIG. 11 illustrates an exemplary DVR TAD main menu screen according to the invention;

FIG. 12 illustrates a submenu associated with message management, including auto callback and external transmission of messages in accordance with the invention.

FIG. 13 illustrates a submenu associated with a displayed directory, including entering caller information and accessing stored caller data;

FIG. 14 illustrates how to send caller information in text and/or sound file format to a remote destination;

FIG. 15 illustrates a submenu of an exemplary private box arrangement requiring password entry; and

FIG. 16 illustrates an alternate embodiment of a DVR TAD connected to an external mass storage device and the host processor of the STB equipped with DVR in accordance with the invention.

### DETAILED DESCRIPTION

In accordance with the present invention, there is a system and method that provides the ability to maintain a digital telephone answering device on a STB-equipped with DVR utilizing the audio and video features of the STB-equipped with DVR and associated display device(s) connected thereto. The DVR TAD utilizes the same telephone line as the STB-equipped with DVR, and may use memories that are integrated within the STB with DVR architecture, and/or an external mass storage device or memory.

Memory devices within the DVR are used by the DVR TAD for storing a plurality of parameters and data typically associated with a DVR TAD. A microprocessor within the DVR controls DVR TAD functionality and display of parameters associated with the DVR TAD. Control is based on receiving user commands to access the memory and to display at least a selected one of the DVR TAD associated parameters for review and/or manipulation by the viewer on a display device operatively connected to the STB-equipped with DVR. A suitable interface such as a remote control may be used in order to transmit a command to display desired DVR TAD parameter(s) or associated data.

A DVR TAD main menu or guide may be depicted on a TV or other display device, effected via a user command interface to the DVR, such as by operation of a remote control device to send commands to a processor within the DVR, for example, and manipulated via a graphical user interface (GUI) controlled by the processor.

Parameters, data or features related to the DVR TAD functionality or operability may be accessed, displayed for viewing and/or manipulated by the user or viewer. These features may include a main DVR TAD menu listing of messages received which include a menu display providing the identity of the caller with number and a short text synopsis of the corresponding stored voice message adjacent thereto; a submenu displaying a “catalog” or “phone book” for data entry to access stored caller information, which may include name, phone number and other identifying criteria that may be entered by the user. Additional features include a means to enable the user to choose between a text display or voice playback of a recorded message; menu features enabling the user to send a stored voice and/or text message to another person via a medium such as the internet (i.e., transmitting an e-mail message with text file or sound file attached thereto) and other attributes associated with the functionality and operation of the DVR TAD.

Also, if a user wishes to phone to the caller back after confirming a message recorded by the caller, a phone call can be automatically made to the caller via an interface in accordance with the control of a microprocessor of the STB equipped with DVR, by selecting a phone message from the list displayed on a display device and actuating a specific key. If the DVR TAD according to the invention is employed by a plurality of users or as a private voice box, a secret number such as a password may be assigned to each of the users so that a message can only be accessed by a corresponding user.

Therefore, the present invention enables a viewer to be provided with a DVR TAD that has enhanced functionality as compared to conventional DTADs, since it utilizes existing hardware and software architecture of a STB equipped with DVR to which it is operatively connected. As will be explained in further detail later in this disclosure, the DVR TAD is capable of storing an enormous amount of telephone messages as compared to current DTADs. Moreover, various menu screens associated with DVR TAD features, data or parameters may be displayed and manipulated by the user operating a simple graphical user interface such as a remote control, providing even greater flexibility.

However, before describing the above features in greater detail, the inventors initially offer a general discussion on a set-top box (STB) equipped with a digital video recorder (DVR) within a direct broadcast satellite or digital video broadcast (DVB) system. Additionally, the basic architecture and operation of the STB-equipped with DVR is explained in order to provide a context for the DVR TAD that is operatively attached thereto, such that a viewer can monitor various functions or parameters of the DVR TAD on a display device operatively connected thereto.

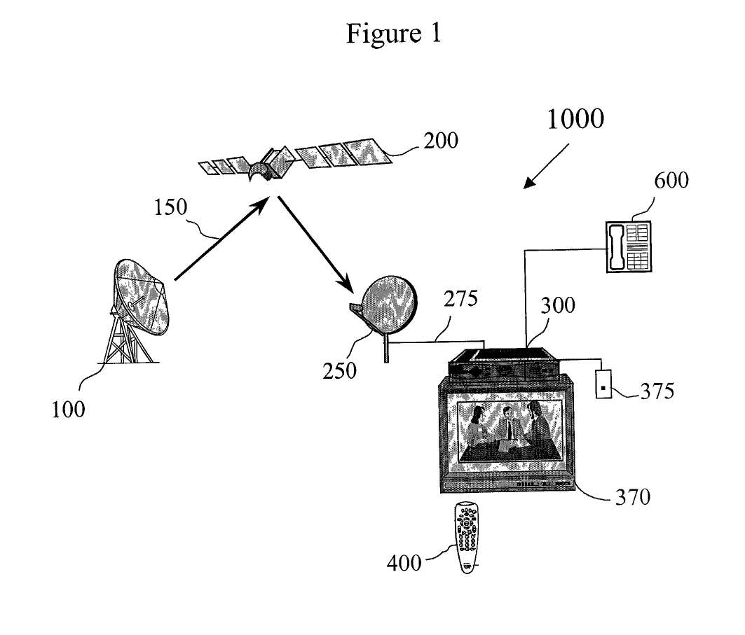

FIG. 1 is an exemplary arrangement of a STB 300 equipped with a DVR and DVR TAD within a direct broadcast satellite or digital video broadcast (DVB) system, in accordance with the present invention. In the exemplary embodiment of FIG. 1, the system 1000 may comprise a transmit antenna station (hereinafter referred to as uplink facility 100 for clarity), satellite 200, receive antenna 250, STB 300 equipped with DVR (within STB 300) and DVR TAD 600 operatively attached thereto.

The transmit antenna station may be a DIRECTV satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 1, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buttons residing on the STB or DVR structure itself, a keyboard operatively connected thereto and/or connected to a PC that is in communication with the STB, USB serial ports, voice-activation software devices within or operatively connected to the STB, or command and/or instructions by remote call-in using DTMF (Dual Tone Multifrequency) tones for example, may be substituted as the user command interface to the STB or DVR, and/or to control designated functions of the TAD connected thereto, as will be explained in detail hereinafter.

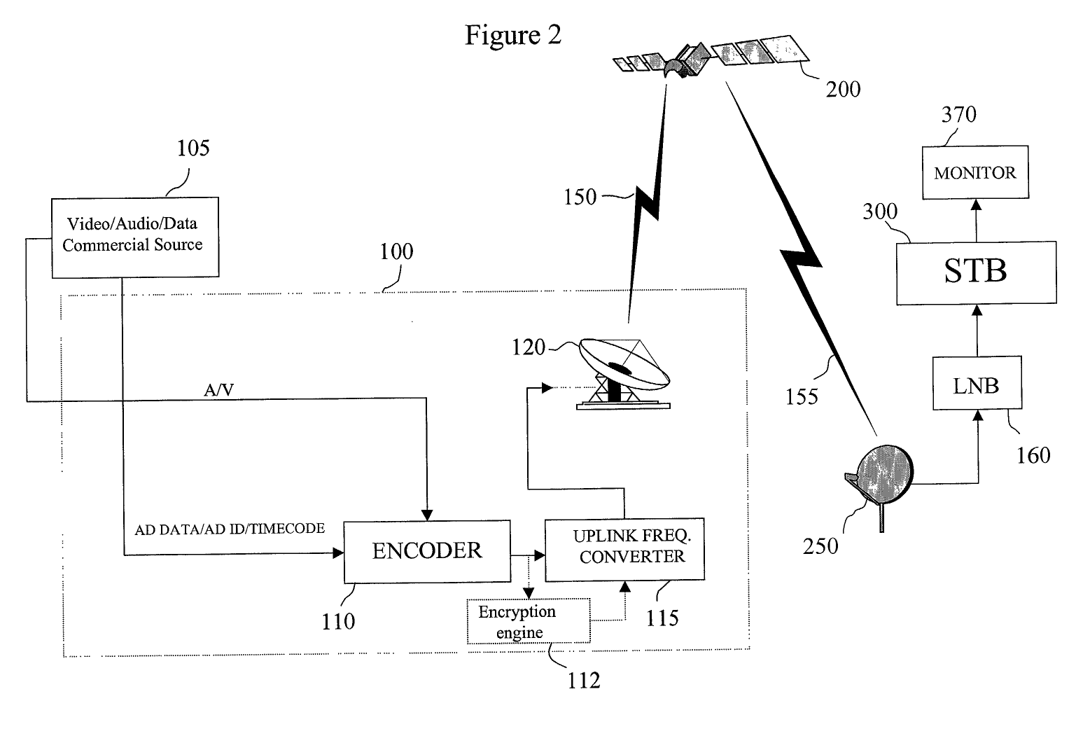

FIG. 2 provides a general understanding of the overall system organization, by illustrating the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 that converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

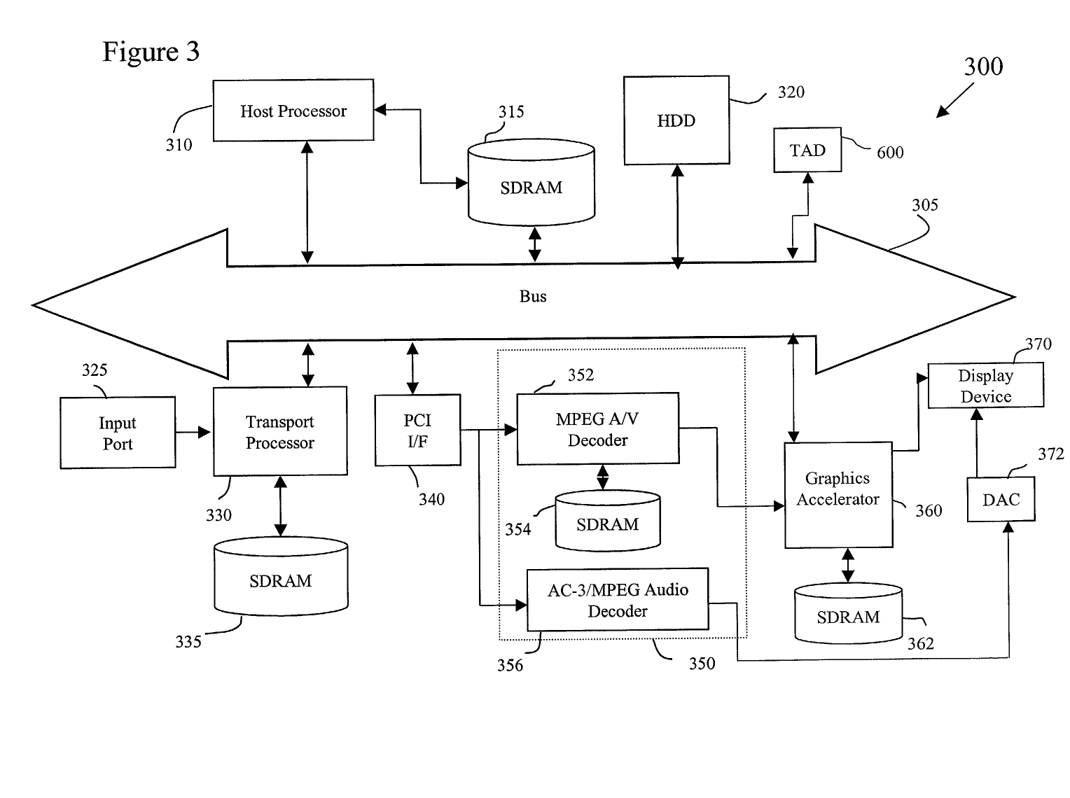

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 3) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 3 illustrates an exemplary architecture of the STB 300 with TAD 600 connected thereto in accordance with the present invention. The STB 300 utilizes a bus 305 to interconnect various components and to provide a pathway for data and control signals.

FIG. 3 illustrates a host processor 310, a memory device 315 (in an exemplary configuration embodied as an SDRAM 315) a hard disc drive (HDD) 320 and a TAD 600 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 3, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG AN decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300 and TAD 600, such as control of attached components, graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript(tm). Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

In addition to performing the aforementioned non-real time functions, host processor 310 also contains a voice recognition engine, which may be embodied as any of an algorithm, software or program that is well known in the art to be used to convert digital voice into digital text. For example, a suitable algorithm may be similar to well known software developed in order to translate voice data into a visual text display for the deaf, closed caption systems, reverse text-to-speech (TTS) synthesis processing systems, and automatic speech recognition (ASR) engines such as is described in U.S. Pat. No. 6,138,095 to Gupta et al. entitled “Speech Recognition”.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause (live cache) recording applications in STB 300.

HDD 320 thus provides enormous storage capacity for the storing of telephone messages and associated caller-ID information that may be stored in a suitable directory database of names. For example, assuming only one (1) Gbyte of the HDD 320's memory is allocated for DVR TAD 600 operation, this translates (at 32 kbits/sec) to in excess of 70 hours of recording time available for DVR TAD 600 recording operations. Moreover, with the amount of memory dedicated for DVR TAD 600 operations, it is conceivable that telephone directory-sized databases can be stored and managed by a user without significantly burdening the overall processing capability of STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 3 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

Input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 3 has been described in conjunction with digital television, the signal supplied could be any type of television signal, any type of audio or video data, including of course analog voice data over a telephone line, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the host processor 310 may perform the decryption instead.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (AN) data may be sent to the host processor 310's memory (SDRAM 315) while simultaneously being sent to an MPEG A/V decoder 352, as further discussed below.

Decoder 350 may be constructed as shown in FIG. 3 by including the MPEG AN decoder 352 connected to the PCI I/F 340, as well as an AC-3/MPEG audio decoder 356 that are also connected to the PCI I/F 340. In this way, decoders 352 and 356 can separately decode the video and audio bitstreams from the PCI I/F 340, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG AN decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

A graphics accelerator (GA) 360 includes processing circuitry for performing graphics processing of a decoded input video stream, and encoding -circuitry for encoding and converting the processed video to analog prior to outputting it to display device 370. GA 360 also includes a memory interface that communicates with an SDRAM 362 in order to direct the incoming video bit stream to a specific storage location in SDRAM 362, and also selects the frames and frame order for display.

Display device 370 may be an analog or digital output device capable of handling a digital, decoded output from the GA 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices that are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from GA 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems that can reproduce the encoded audio and/or video signals for reproduction and/or display. This may also include a PC that can play video or audio files containing the encoded A/V data sent from the STB 300, for example. In such an embodiment, text or voice files could be sent from the STB 300 to the PC in the form of an e-mail message with text or sound file as an attachment thereto, as will be explained in more detail hereinafter

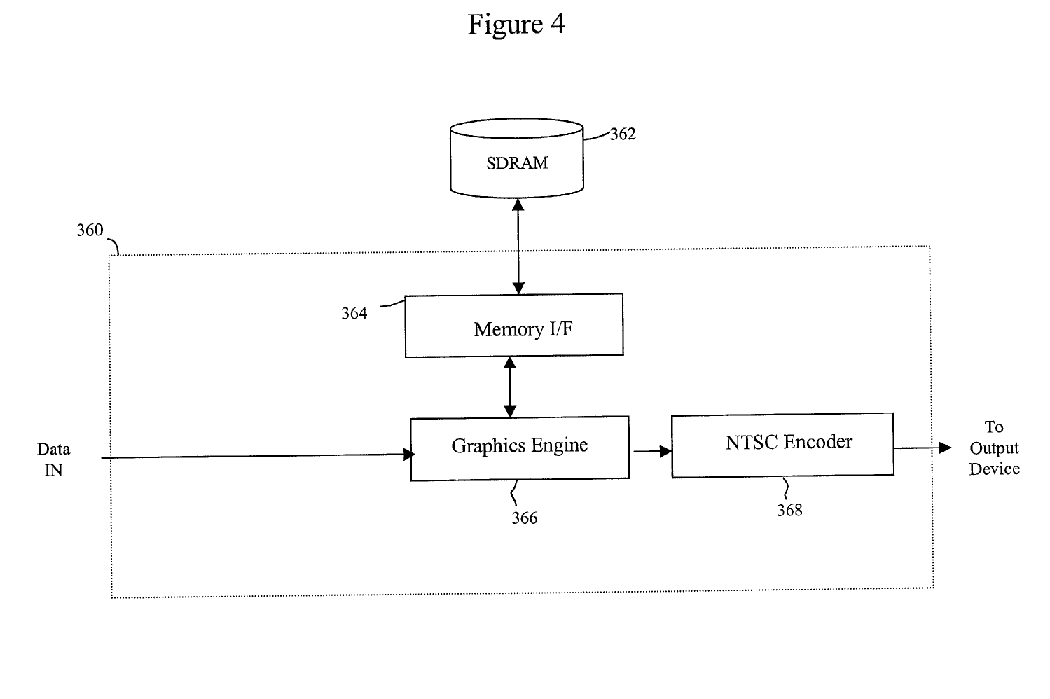

FIG. 4 is a block diagram showing an exemplary construction of the graphics accelerator according to the invention. The GA 360 preferably is a graphics chip that includes a memory interface (I/F) 364 to SDRAM 362, a graphics engine 366 and a TV encoder 368. The memory interface 364 and TV encoder 368 are shown embedded in GA 360; however, these components may be separate or external from GA 360.

Memory I/F 364 is preferably an industry standard SDRAM interface, but may also be one of a PCI bus, RAM bus, DDR (double data rate) and EDO RAM (Extended Data Output DRAM) interface used in the art. Memory I/F 364 controls access to a display memory portion in SDRAM 362. In particular, memory interface 364 informs the incoming video data where it is to be stored in SDRAM 362. Additionally, memory I/F 364 selects the decoded data (which are being stored in SDRAM 362) that are going to be displayed on display device 370.

Graphics engine 366 may preferably be a 64-bit DRAM based XVGA controller with hardware accelerated BitBLT (bit block transfer), video playback and video capture to a frame buffer (SDRAM 362 for example). However, graphics engine 366 should not be limited to this specific implementation. In other words, the graphic engine 366 may be implemented with other controller technologies.

TV encoder 368 is preferably an NTSC encoder that encodes, or converts the digital video output from graphics engine 366 into a coded analog signal for display. Regarding the specifications of the NTSC (National Television Standards Committee) encoder 368, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. The SECAM standard was introduced in the early 1960's and implemented in France. SECAM uses the same bandwidth as PAL but transmits the color information sequentially. SECAM runs on 625 lines/frame.

Thus, although use of an NTSC encoder for TV encoder 368 is envisioned to encode the processed video for display on display device 370, the present invention is not limited to this standard encoder. PAL and SECAM encoders may also be utilized. Further, developing HDTV encoders may also be viable to encode the processed video for display on a HDTV, for example.

SDRAM 362 is similar in its construction to SDRAM 315. SDRAM 362 provides the extra frame buffers (sufficient memory, preferably at least 2 Mbyte or greater) necessary to temporarily store the decoded data prior to being output for display on display device 370.

As seen in FIG. 4, the decoded video data is input into graphics engine 366, whereby it is subject to graphics processing to prepare the data for system to display transfer. Memory interface 364 instructs SDRAM 362 to output the selected data for playback to graphics engine 366. Thereafter, the data for display can be encoded and converted to analog at TV encoder 368 before being sent to display device 370.

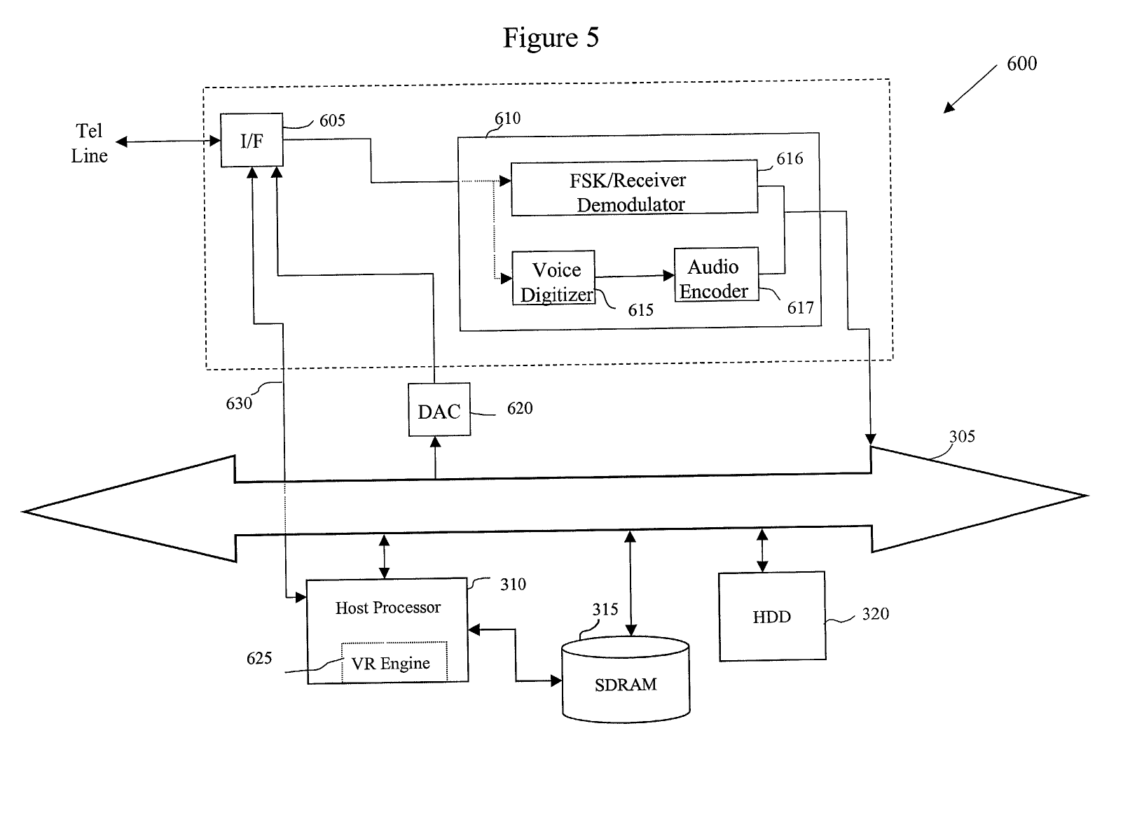

Up to this point, the overall architecture of the STB with DVR has been illustrated and briefly described in connection with the present invention. FIG. 5 illustrates a partial block diagram of FIG. 3 to show the components associated with the DVR TAD 600 portion of the STB equipped with DVR and TAD.

Circuitry of the DVR TAD 600 illustrated in FIG. 5 is physically located within a separate DVR TAD body (not shown) that includes a handset and local function keys thereon that are similar to well known DTADs. Thus, although a detailed description thereof is omitted, an exemplary DTAD body and keyboard may resemble the example illustrated in FIG. 3 of U.S. Pat. No. 5,400,393 to Knuth et al., entitled “Voice Mail Digital Telephone Answering Device”. Additionally, although many of the features of the DVR TAD 600 described in accordance with the invention are illustrated as a user sending commands to a microprocessor via a remote control, commands or functions may of course be initiated locally be manipulation of keys or button of a keyboard on the DVR TAD 600.

Referring now to FIG. 5, DVR TAD 600 includes a high impedance telephone line interface 605 that receives analog voice signals along with the Caller ID signals that are generated by the telephone network or service provider. Additionally, interface 605 is configured to receive DTMF signals in addition to analog voice signals. The Caller ID and analog voice signals are sent from telephone line interface 605 to be received by a TELCO modem 610. TELCO modem 610 includes an FSK/receiver demodulator 616 and a Voice Digitizer 615. FSK/receiver demodulator 616 demodulates the Caller ID signals to provide a digital representation of the received telephone number, and Voice Digitizer 615 converts the received analog voice to a digital voice signal.

The digital voice signal output from Voice Digitizer 615 is then encoded in an audio encoder 617 before being routed to STB 300. Audio encoder 617 may be an MPEG encoder for example, but is not limited to MPEG encoding, as other techniques or encoders known in the art like a WINDOWS media encoder may be used. Alternatively, instead of providing a hard-wired audio encoder 617 in DVR TAD 600, host processor 310 may effect encoding of the input digital voice signal using embedded encoding algorithms or software.

Although the DVR TAD 600 interface between the phone line and STB 300 is described as a TELCO modem 610, the present invention is not limited to such. Alternatively, the interface between STB 300 and an external device (such as a caller, PC, etc.) could be any of DSL, Home LAN, cable modem, satellite or optical interface, and any other known communication interface which would enable communication between STB 300 and an external device. Such an interface could enable the communication of text or sound files to be passed digitally, under control of host processor 310 from HDD 320 through the suitable interface (via a serial port in STB 300 for example) to an external device such as a PC.

The TELCO modem 610 then outputs the collective digital representation of voice and phone number via PCI bus 305 to be processed by host processor 310, then temporarily stored in buffer 315 for ultimate storage in HDD 320. Within host processor 310 is the previously discussed voice recognition engine 625 that converts, under the control of the host processor 310, the digital voice received (and stored in HDD 320) to a text representation that may be displayed after decoding and encoding on a suitable display device 370.

As will be explained further below, there is also a DAC 620 operatively connected between 305 and telephone line interface 605. DAC 620 is a digital to analog converter, and outputs an analog signal to be transmitted to the telephone network or service provider. This signal may be an out going message (OGM) sent to a caller by the DVR TAD 600. Additionally, there is a signal line 630 between telephone line interface 605 and host processor 310 that represents a communication path for detection of OFF-hook and ON-hook signals. These OFF-hook and ON-hook signals are sent to host processor 310 to determine whether or not DVR TAD 600 will be placed in some active state (answering or recording a message) or an idle state. Line 630 also enables the transmission of a digital auto callback dialing signal from the STB 300 to a desired caller, via interface 605 and the telephone line. This auto callback dialing signal may be embodied as DTMF tones.

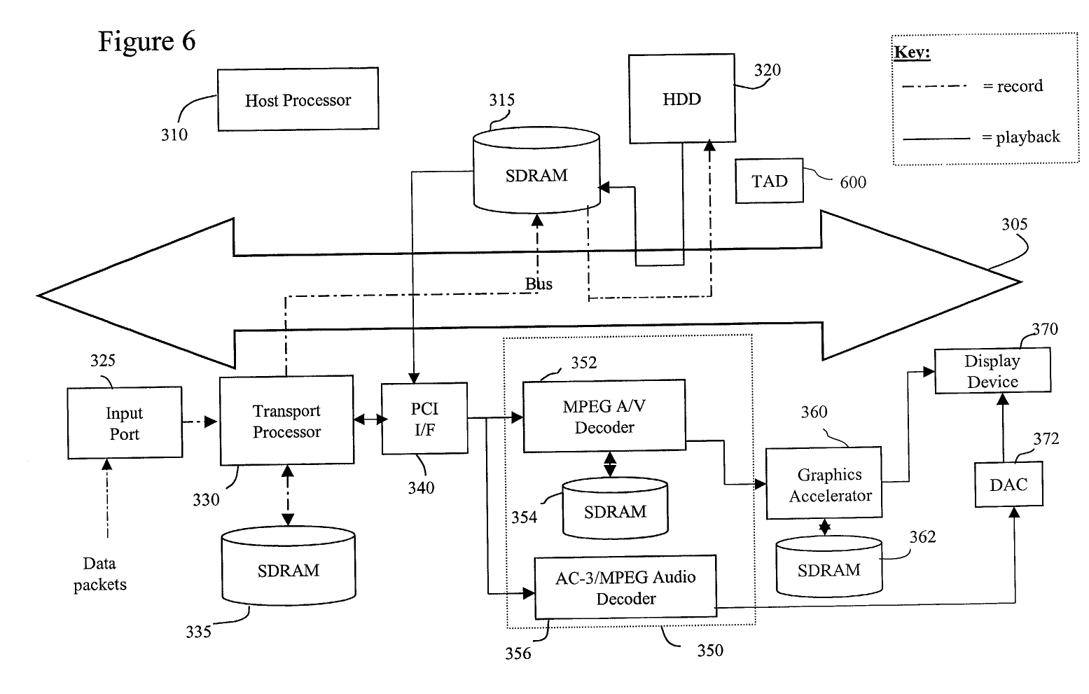

General recording and playback paths of the STB 300 are described in accordance with FIG. 6. FIG. 6 shows the recording and playback data flows among the various components of the STB 300, and is background for the recording and playback paths for DVR TAD 600 operations that are discussed later below. Some of the connections between components, and associated reference numerals from FIG. 3 may have been eliminated in FIG. 6 in order to highlight the data flow that is shown using dashed lines (see Key).

As shown in FIG. 6, A/V data of a selected or desired event, program and/or broadcast is received by input port 325 (typically the data is received in packetized and encrypted form) and fed to the transport processor 330. The transport processor 330 then transfers the received AN data to SDRAM 315. Digital recording is accomplished by the host processor 310, which transfers the AN data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SD RAM 315, the host processor 310 transfers the data from the SDRAM 315 to the HDD 320 for recording therein.

In an alternative record path, A/V data is fed from the input port 325 to the transport processor 330. The transport processor 330 then transfers the received audiovisual data to the PCI I/F 340. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that temporarily stores data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 6, when the viewer turns the STB 300 on, the viewer is given the option to playback any of the previously recorded programs, events, broadcast, phone messages, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 PCI I/F 340, which in turn sends the selected A/V data to decoder 350. More specifically, the video portion of the bitstream is sent to MPEG AV decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to GA 360 for conversion to an analog format, so that it may be displayed on display device 370. From this point on, the playback data looks, for all intents and purposes, identical to the originally recorded event, program, broadcast, etc.

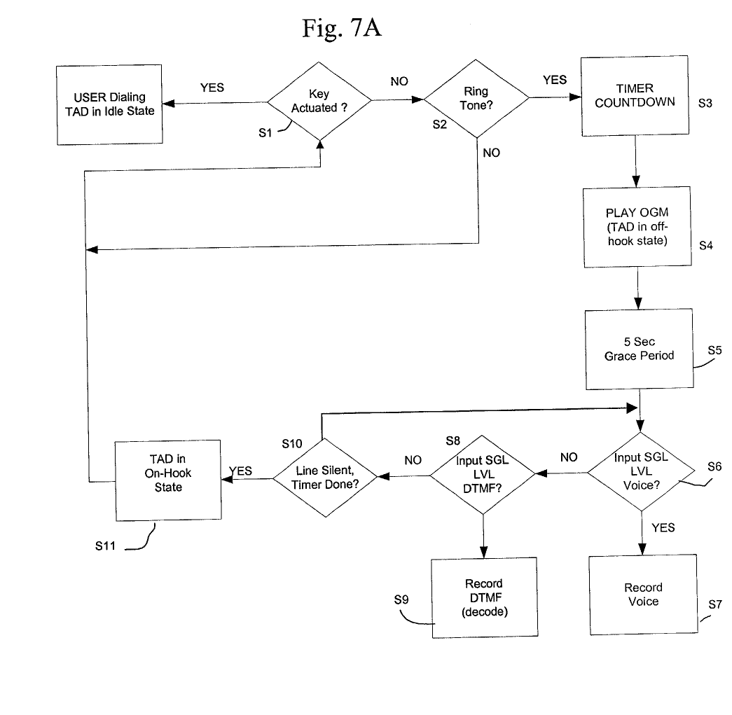

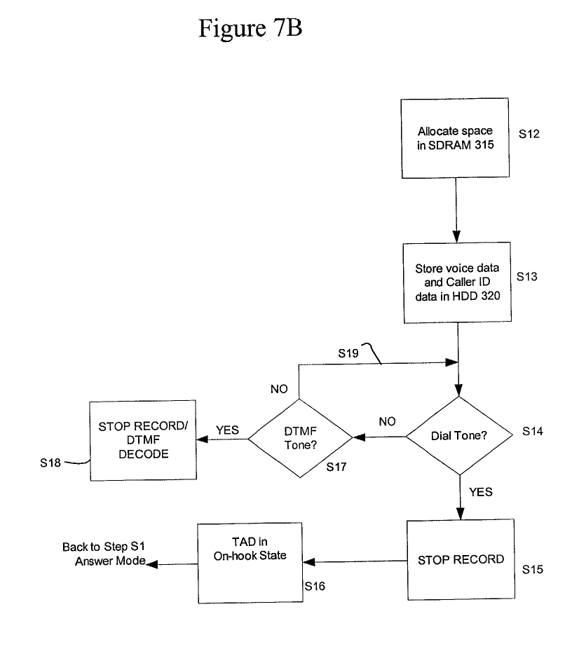

The architecture of the STB 300 and the operations of general recording and playback having been described, exemplary answer and record modes of the DVR TAD 600 are now explained in reference to FIGS. 7A and 7B.

Referring to FIG. 7A, the DVR TAD 600 first determines (Step S1) if the user has pressed a number key on the TAD keyboard (not shown). This is done under the control of the host processor 310 so as to read data at telephone line interface 605. If the user has pressed a number key, this is an indication that a user is calling out and DVR TAD 600 will remain in an idle state. If no key has been pressed, DVR TAD 600 detects if a ring signal is present (Step S2). Since any ring detection is immediately transmitted to host processor 310 via line 630, host processor 310 will initiate a timed countdown (Step S3), in which it reads a predetermined variable out of SDRAM 315 indicating the number of rings to wait before answering. For example, this could be set to answer immediately, at two, four, eight rings, etc. The finite time duration corresponds to the number of rings, after which host processor 310 accesses an outgoing message (OGM) pre-stored in SDRAM 315 to be sent out to the caller (Step S4) via DAC 620 and interface 605. DVR TAD 600 is thus placed in an off-hook state while the OGM is played back to the caller

When the playing of the OGM is completed, host processor 310 preferably waits 5 seconds (Step S5). This 5-second grace period prevents malfunction of the DVR TAD 600 due to silence by the natural pause or hesitation of a caller before or during enunciation of a message. The host processor 310 then determines if voice signals, or DTMF signals are being transmitted. The host processor 310 can distinguish three states during a call—voice signals, DTMF signals, or dial tone/silence—by reading the level and modulation of the signals on the telephone line. The host processor 310 distinguishes between the tones of DTMF signals and the signal level ranges associated with human speech detected on the telephone line. If voice signals are detected (Step S6), the host processor 310 immediately executes a voice record routine (Step S7) already outlined with reference to FIG. 6. If no voice is present on the line, but DTMF signals are being transmitted (Step S8), the host processor 310 executes a DTMF decode routine (Step S9) that is well known in the art and therefore only generally explained herebelow.

If, however, there is determined a dial tone or silence (Step S10) lasting for 5 seconds, the host processor 310 causes the DVR TAD 600 to go into an on-hook mode (Step S11) which hangs up the phone and terminates the call, otherwise returns to Step S6 again. (Modify FIG. 7A, show No for arrow going back to Step 6.) The DVR TAD 600 now returns to its initial state in the answer mode routine of looping and checking for a user key touch and waiting for a ring signal.

A DTMF routine preferably would be initiated by host processor 310 and decodes the DTMF signals keyed into the telephone by the caller and stores the code in SDRAM 315 and links it to the HDD 320 if a voice message is recorded. This process sets up data memory areas in SDRAM 315 for receiving the DTMF signaling and links the data memory to voice message memory areas in HDD 320 if a voice message has already been recorded. If a voice message has not yet been recorded it allocates an available message number in case a voice message is left later. This allows the system to be flexible and will allow the caller to key in a DTMF I.D. code anytime during the message sequence.

FIG. 7B illustrates an exemplary record mode for DVR TAD 600 in accordance with the invention. Initially, temporary space in SDRAM 315 is allocated (Step S12) for storing the received digitized signals, in order to allow time for the host processor 310 to prepare HDD 320 for storage. This step points to a data memory position for the caller ID signal, and a voice memory position for the message in SDRAM 315. When HDD 320 is ready, it is accessed by host processor 310 in order to store the caller ID and voice data together (Step S13) (i.e., they are linked and associated within HDD 320).

These digital signals are being stored in parallel with a task of determining the line status. This is where host processor 310 first checks for a dial tone via line 630. If it is found (Step S14), recording is stopped (Step S15) and the DVR TAD 600 is placed in an ON-Hook state and returns to the answer mode (Step S16). If no dial tone is found, the line is checked for a DTMF tone and if that is found (Step S17), the aforementioned DTMF routine is performed (Step S18). On the other hand, when a DTMF tone is not detected, a dial tone is re-checked (Step S19), and once the dial tone is present, DVR TAD 600 is placed in an ON-Hook state and returns to the answer mode.

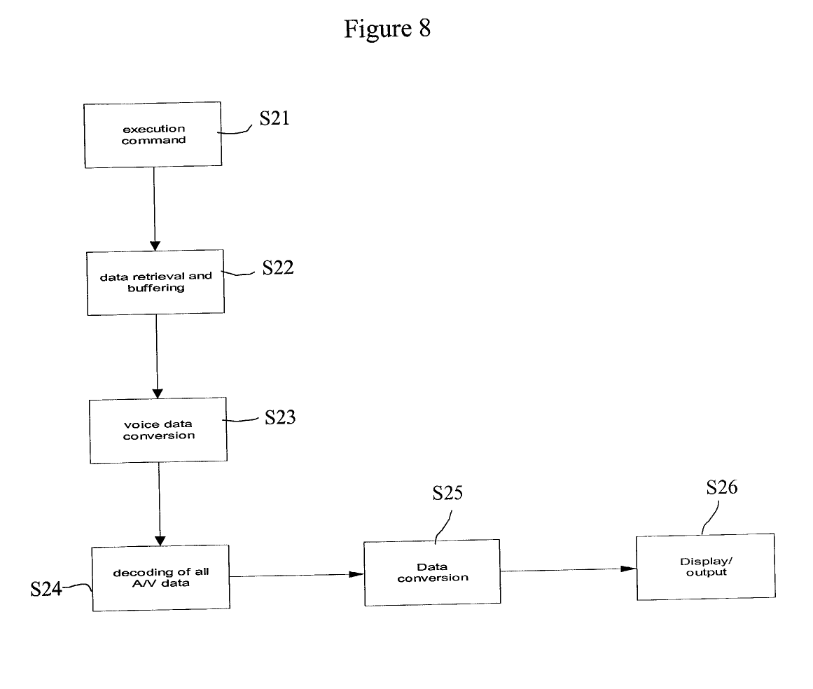

FIG. 8 illustrates a general playback flow diagram for a stored voice message in accordance with an exemplary embodiment of the invention. By utilizing a suitable interface, a user or viewer may elect the option to playback any of the previously recorded telephone messages on a display device 370 operatively attached to STB 300. This may be done, for example, by using a remote control or other suitable user command interface (not shown) to access a menu on a screen of the display device 370. If the viewer selects a desired message for playback on the screen, the corresponding A/V data (hereinafter “DVR TAD data” for clarity, which in an exemplary case could be requested as text only or voice only) is retrieved from HDD 320. In general, DVR TAD data could be digital voice, text and/or Called ID data.

In particular, when the user desires to playback a recorded phone message, he/she sends a command (Step S21) to host processor 310 directing that the corresponding DVR TAD data recorded on HDD 320 be retrieved from HDD 320, via bus 305 to a queue in SDRAM 315 (Step S22). In the event the user desires to read a text representation of the voice message, the digital voice data portion of the DVR TAD data is subject to processing by voice recognition engine 625, which converts the digital audio voice data (Step S23) to text. However, and as will be illustrated hereafter, the voice data will be recognized and converted to text and temporarily stored in SDRAM 315 regardless if the user desired text or a voice reproduction. This is because at least a “header portion” or start of message text representation will be displayed on display device 370, such that the user may at least visually review at least part of the message. This format may be similar to formats in electronic mail systems that can be configured to show a partial message in a sub-window when the user highlights the message sender name in an inbox.

Next, the buffered text data along with the original digital voice data and caller ID data of the message is sent as a DVR TAD data stream from SDRAM 315 via bus 305 to PCI I/F 340, which in turn sends the selected DVR TAD data to decoder 350 (Step S24). More specifically, digital caller ID and text data are sent to GA 360 through MPEG A/V decoder 352, with the audio portion (digital voice) being sent to AC-3/MPEG audio decoder 356. Alternatively, the DVR TAD data can be conveyed to MPEG A/V decoder 352 since decoder 352 is capable of decoding audiovisual data. Thereafter, the text and caller ID data portions of the DVR TAD data stream are displayed on display device 370, and the digital audio data portion of the DVR TAD stream is fed to DAC 372 to convert it to analog sound, for emission from a speaker of display device 370, if desired.

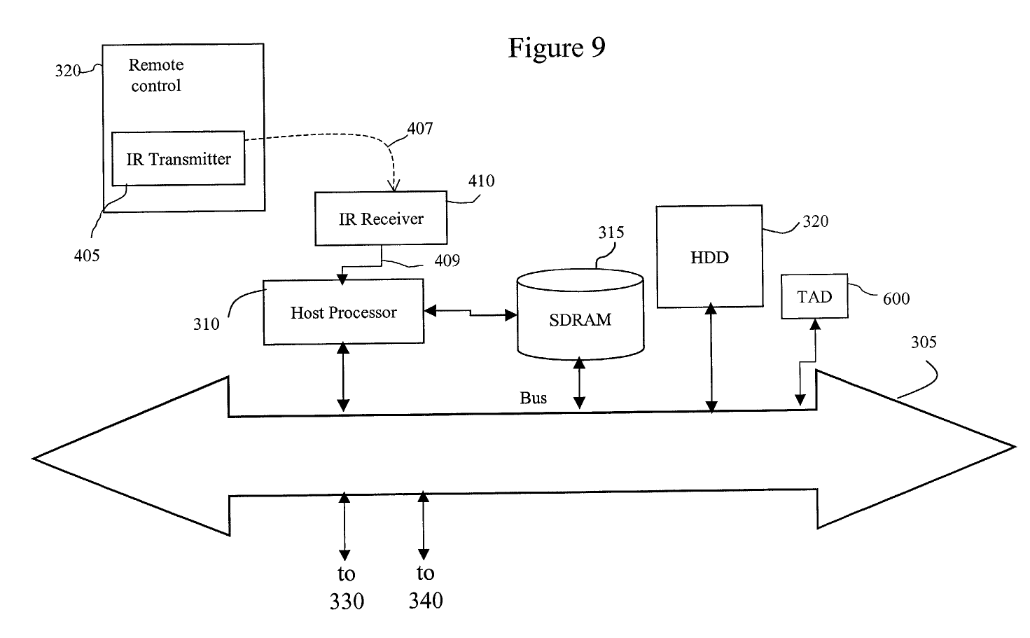

FIG. 9 illustrates a partial block diagram of FIG. 3, so as to show an exemplary communication path between a remote control device 400 (not shown in FIG. 8) and the host processor 310 of STB 300. In FIG. 9, there is illustrated a remote control device 400 which is in communication with the host processor 310 in order to send commands for operating features or functions of the DVR TAD 600 and/or to display menus associated with DVR TAD 600 operation and functionality on display device 370 for example. The remote control device may be a device that is specific to the STB 300 or TAD DVR 600, and/or may be a universal remote control device which controls various individual components connected within a home entertainment system (TV, stereo, tape deck, DVD player, CD player, STB, TAD, etc.)

As is well known in the art, the remote control device 400 may include a remote control transmitter 405 therein for transmitting various key or pushbutton-associated signals (commands) selected by the viewer or user to perform certain DVR TAD functions, to display certain parameters or data associated with the STB 300 and/or DVR TAD 600. These are sent in the form of an infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to host processor 310. The host processor 310 thus analyzes the composed code information (i.e., the command data generated by the user) corresponding to the received system drive signal 409. This may be a command to display a desired parameter, menu or user-interface feature of the DVR TAD 600, for example.

Although the above communication path and interface to the STB 300 and DVR TAD 600 are explained with regard to using a remote control device, commands and/or processing necessary to display DVR TAD 600 parameters may also be initiated by a user actuating buttons, switches and/or keys that may be provided on, and integral with STB 300 and/or DVR TAD 600. Moreover, these buttons, switches and/or keys may interact with software or package programs within STB 300 (i.e., provided within SDRAM 315, HDD 320 or as part of host processor 310) in order to effect display of a status parameter on a screen of a device. These alternative interfaces provide redundancy for the viewer, as well as alternative means to display parameters, menus or functions of STB 300 and/or DVR TAD 600 on a display device 370.

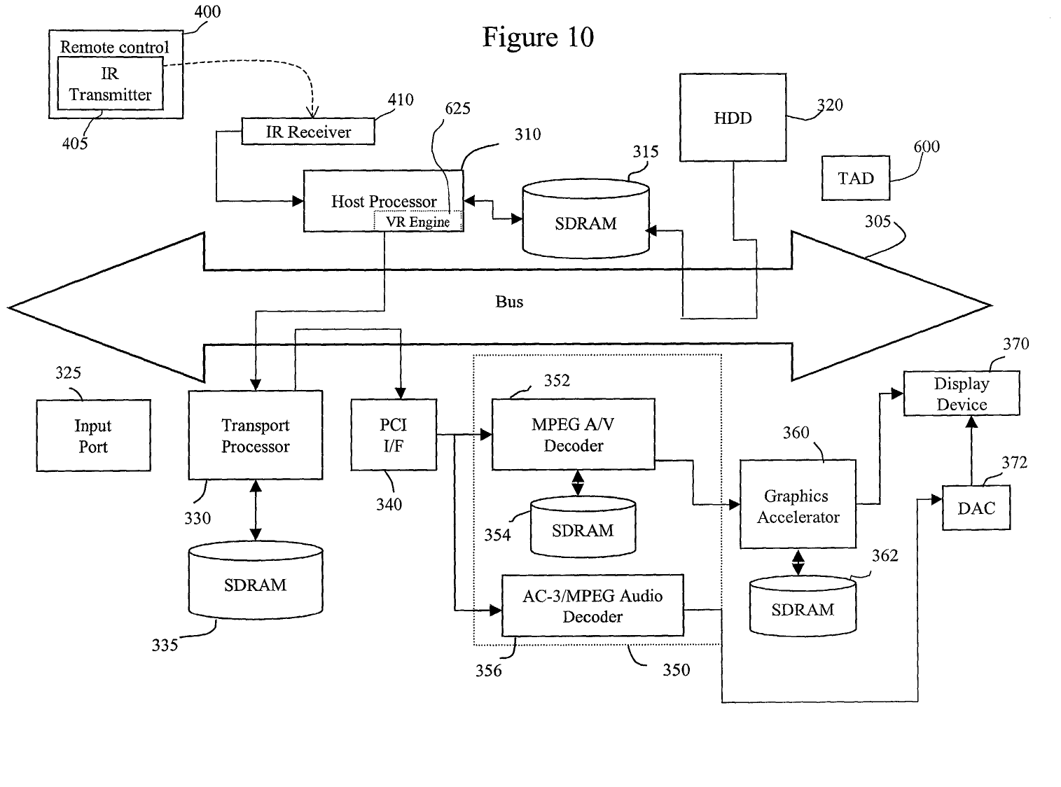

FIG. 10 illustrates the data flow from command signal to display, for a parameter, data or menu associated with DVR TAD 600 in accordance with the present invention. A plurality of parameters or data, such as recently received phone messages, data for specific DVR TAD-related menus, etc., are stored in HDD 320. Additionally, certain ones of these stored parameters may be updated to reflect current status of the DVR TAD 600; for example, TAD off-line, number of messages received today, etc. This may be done, for example, by using designated software programs or predetermined algorithms within host processor 310.

The host processor 310 receives an IR ray signal (i.e., a command) from remote control device 400 that is converted into a digital signal. This signal may be a command directing that a certain parameter, menu or data associated with the DVR TAD 600 be displayed. Thus, host processor 310 retrieves the ordered DVR TAD data (this may be any or all of the digital audio, text or caller ID data, depending on the selected parameter and/or feature) from HDD 320 via SDRAM 315, where it is buffered temporarily after being sent from HDD 320, so that the voice data may be processed by voice recognition engine 625. Host processor 310 sends the selected data (i.e., digitized voice, digital text and caller ID signals) corresponding to the desired parameter, menu of function via bus 305 as a DVR TAD stream to PCI I/F 340, which in turn sends the selected data to decoder 350. From this point, the flow path is identical to that for playback described initially in FIG. 6. The decoded DVR TAD data is output to GA 360 for conversion to an analog format as required, so that the desired parameter may be displayed on display device 370.

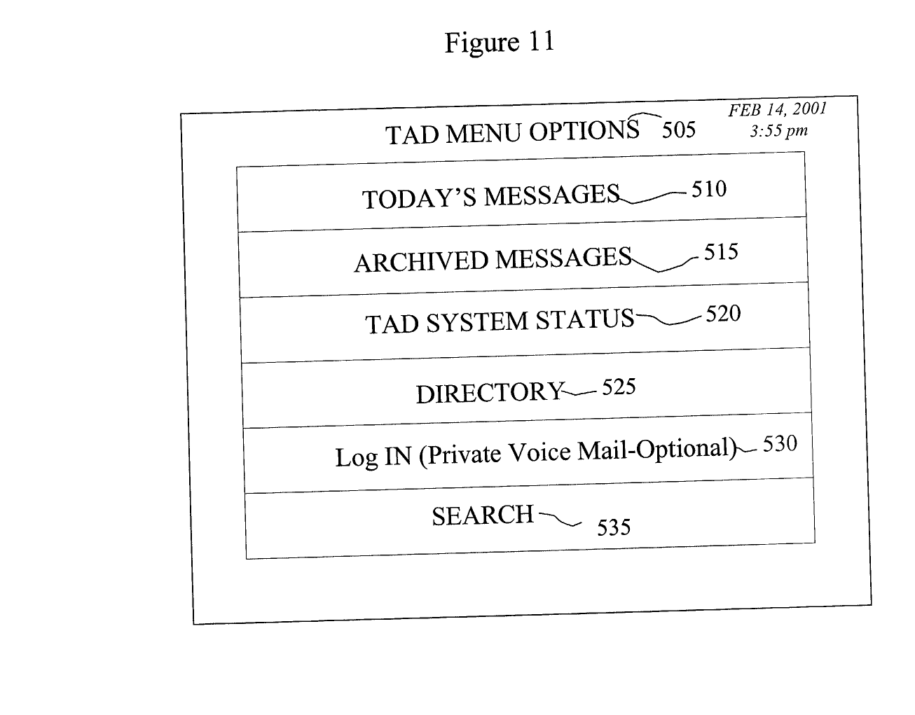

FIG. 11 illustrates an exemplary DVR TAD 600 main menu screen according to the invention. When a user or viewer sends a command to display a TAD main menu, an exemplary menu 500 or status guide such as is depicted in FIG. 10 may be displayed on the screen of a display device 370. In an exemplary embodiment, various status parameters or features may be displayed in stacked cells or rows of the menu 500, each cell being assigned to a particular status parameter.

As shown in FIG. 11, a title line 505 such as “TAD Menu Options” may be provided, along with various DVR TAD 600 parameters or functions such as a “Today's Messages” cell 510, “Archived Messages” cell 515, “TAD System Status” cell 520, “Directory” cell 525, “LOG-IN to access private voice mail” (optional) cell, 530, and a Search cell 535 to quickly access caller information. These features are only exemplary of the many other possible features or parameters of the DVR TAD 600 that a user may display in order to review.

To view the desired parameter, and/or to manipulate or display additional information such as sub menus, specified callers, etc., the viewer simply presses a designated key either on remote control 400, or locally at STB 300 or DVR TAD 600. In the exemplary embodiment this may be a scroll down key, left/right or up/down arrow button, for example, in order to highlight a specific cell. The parameter of the highlighted cell may then be actuated or implemented on the display by pressing an execution key, button, etc. on the remote control 400 or STB 300/DVR TAD 600, such as an “action”, “enter” or “execution” key as is known in the art. The present invention is not limited to these user command interfaces, of course, as any of the other exemplary user command interfaces may be implemented as well (i.e., in the event a PC is connected to STB 300, an input device such as a mouse may serve as the command interface).

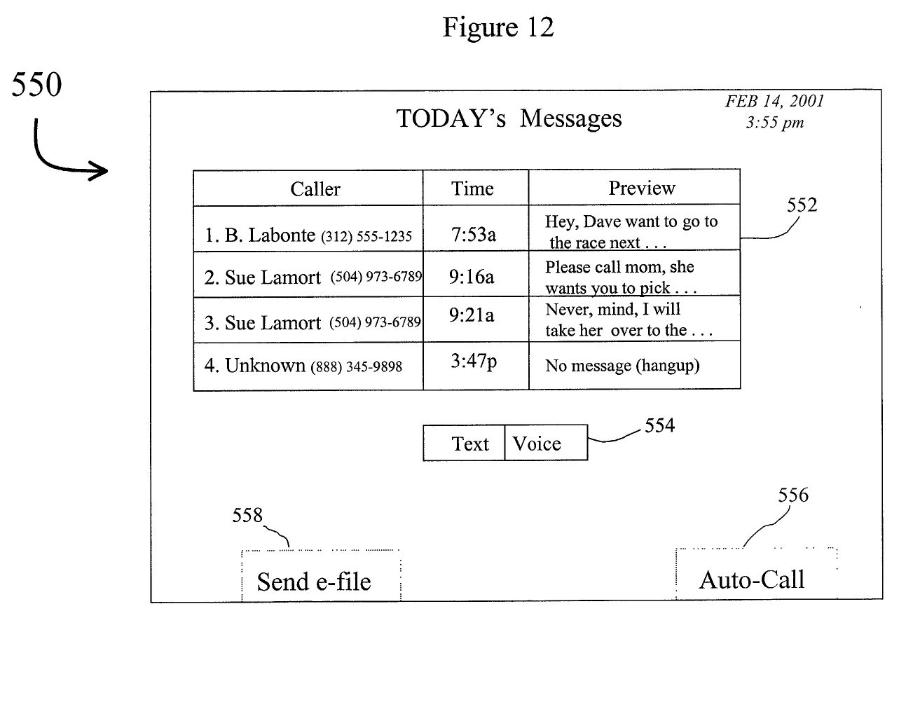

FIG. 12 illustrates a submenu associated with message management, including auto callback and external transmission of messages in accordance with the invention. Should the user select the “Today's Messages” cell 510, a submenu entitled “Today's Messages” may be displayed on the display device 370. Submenu 550 includes a cell or window 552 listing the messages received that day. Each message includes the caller name and phone number, and may be identified by the caller ID information received from the telephone network provider. Alternatively, in the case that the user does not subscribe to a Caller ID service, the caller may be identified from the recorded dial or DTMF tones that are identified by host processor 310 as matching a DTMF tone signature that corresponds to a name stored in a stored caller database in HDD 320.

Additionally, a short “text header”, or starting portion or snippet of the complete text representation is displayed. The header display is set as a default, and will be displayed regardless if the user elects to read the entire text message or simply elects to hear the recorded voice message at display device 370. As shown in FIG. 11, the user may highlight a particular caller using remote control 400. Then the user has a variety of options. The user may select the “Text” or “Voice” icon 554 to initiate the corresponding playback of a telephone message. Alternatively, the user may simply highlight the header text in the preview area of cell 552 in order to read the full text message. In an exemplary case, this may be embodied as a pull down window that displays the entire message, or a completely separate display containing only the text of the message. However, the display format is not limited to the above, as any suitable and known display implementation in the art is applicable.

Further in FIG. 12, a user may desire to automatically call back the caller selected or highlighted on submenu 550. To do so, a user would highlight the desired caller in cell 552 and then initiate the auto-call cell 556. For example, if B. Labonte was highlighted and the auto-call feature was enabled, host processor 310 would access B. Labonte's phone number stored in HDD 320, so as to produce the DTMF tones that are then sent to DVR TAD 600 (via line 630 through interface 605) for dialing out on the telephone line. Optionally, a confirmation block may be displayed upon selecting a desired caller for auto call back. This may be embodied as pop-up window or sub-screen, or any other display implementation known in the art.

Yet still further, a user may desire to send a text or sound file corresponding to the message of a selected caller to an external medium such as e-mail via the internet. To do so, a user would highlight the desired caller in cell 552 and then initiate the send e-file cell 558. As will be further explained below, this initiates a pop-up window or sub-screen interrogating the user to determine whether a text file of the telephone message, sound (voice) file, or both are to be sent, and asking the user to input the address to send the file to. After selecting the desired parameters, the user simply actuates a send icon in order to direct the host processor 310 to send the specified file via an interface over a suitable telecommunications line to the receiving location. This may be embodied as any of a dial-up modem, cable modem, ISDN, Home LAN, DSL, satellite, etc.

Should the user select the “Archived Messages” cell 515, a submenu entitled “Archived Messages” may be displayed on the display device 370. This menu is essentially identical to that illustrated in FIG. 12, with the exception that the user may set a specified archived period by selecting one of several stored defaults (i.e., 1 week, 1 month, 3 months up to 1 year), or by entering a specified time period using remote control 400, for example.

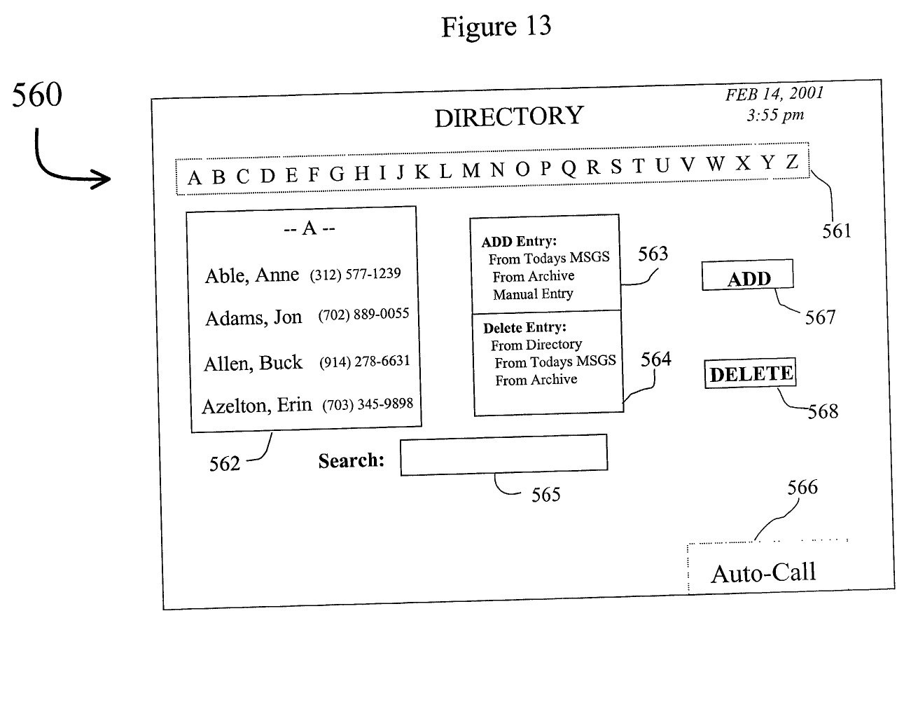

FIG. 13 illustrates a submenu associated with a displayed directory, including entering caller information and accessing stored caller data. Directory submenu 560 includes an alphabetical A-Z list cell 561, address list 562 cell that as a default lists the first few names of A, and can be scrolled down if desired, an add entry cell 563, a delete entry cell 564, search cell 565, and an auto call back cell 566.

A user may access submenu 560 from TAD menu 500 by actuating “Directory” cell 525. Alternatively, actuating Search Cell 535 from TAD menu 500 will highlight the corresponding search cell 565 in submenu 560 to prompt the user the enter the first few letter of the last name of a desired caller. In doing so, address list 562 will simultaneously scroll down to the letters corresponding to the search, similar to what is available in e-mail contact search applications. This provides a quick and easy means of obtaining stored caller identification.

Over time, the user may build up the address list 562 by manually entering caller information. This can be done by actuating the manual option in the add entry cell 563. However, the system of the present invention automatically stores, temporarily in SDRAM 315, incoming caller information that is detected by DVR TAD 600. More preferably, the user will actuate the “From today's messages sub-line or “From Archive” sub-line in add entry cell 563 in order to display a listing of current or archived messages and caller information. Then, the user can simply highlight those names that are desired to be permanently stored in the address list 562, which is embodied as a directory database that is stored on HDD 320, and then actuate an ADD icon 567 displayed on submenu 560, which could also be embodied as a pop-out or pull-down window (not shown) from add entry cell 563. Similarly, the user may periodically review address list cell 562 to delete names from the database, by highlighting the appropriate names using a suitable interface such as remote control 400, mouse, keyboard etc., and then by actuating a delete icon 568 displayed on submenu 560, which could also be embodied as a pop-out or pull-down window (not shown) from delete entry cell 564.

Still further, the present invention envisions the ability to set defaults as to when temporarily stored information residing in SDRAM 315 is to be erased, so as not to overly burden the processing capability of the system. For example, the system could be configured to permanently store (in HDD 320), or erase, caller identification information of the archived messages or most recent (Today's Messages) after a set period of time. Alternatively, and depending on the available storage capacity, caller identification information of all received messages could be permanently stored and organized in HDD 320 by setting a particular default. Such defaults could be set by the user actuating the TAD System Status cell 520, which would display a corresponding sub cell (not shown) of specified system parameters and defaults to be reviewed, set and/or adjusted by the user regarding the management of received message traffic.

A user may also desire to automatically call back a caller selected or highlighted on submenu 560. To do so, a user would highlight the desired caller in address list cell 562 and then initiate the auto-call cell 566. As explained in FIG. 12 host processor 310 would access the phone number of the selected name from HDD 320, so as to produce the DTMF tones that are then sent to the DVR TAD 600 for dialing out on the telephone line. As noted also above, a confirmation block may be displayed upon selecting a desired caller for auto call back. This may be embodied as pop-up window or sub-screen, or any other display implementation known in the art.

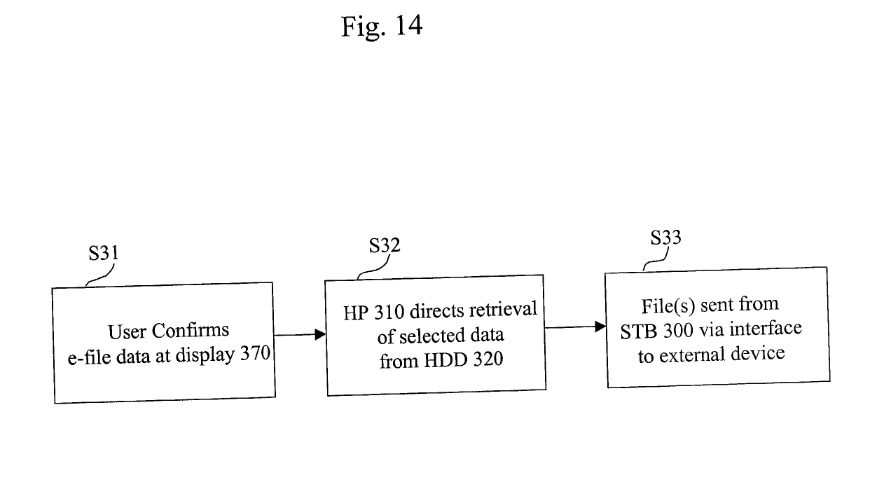

FIG. 14 illustrates how caller information in text and/or sound file format is sent to a remote destination in accordance with the “send e-file” cell 558 of FIG. 12. As noted above, the interface between STB 300 and an external device (such as a caller, PC, etc.) could be any of a TELCO modem DSL, Home LAN, cable modem, satellite or optical interface, and any other known communication interface which would enable communication between STB 300 and an external device. Such interfaces enable the communication of text or sound files to be passed digitally, under control of host processor 310 from HDD 320 through the suitable interface (via a serial port in STB 300 for example) to an external device such as a PC.

For example in FIG. 14, once the user actuates the send e-file cell 558 of FIG. 12, the user may get a confirmation message in pop-up graphical form or on a separate screen of display device 370 to verify (Step S31) that the desired sound and/or text file to be sent to the external device (a PC of another user or the user's PC at work in this exemplary embodiment). Once confirmed, the host processor 310 directs the retrieval (Step S32) of the selected file(s) from HDD 320, for transmission (Step S33) from a serial port of the STB 300 via a suitable interface to the desired location. Preferably, the user could receive a visual prompt on the screen of display device 370 indicating that the file has been successfully sent, or noting errors in transmission.

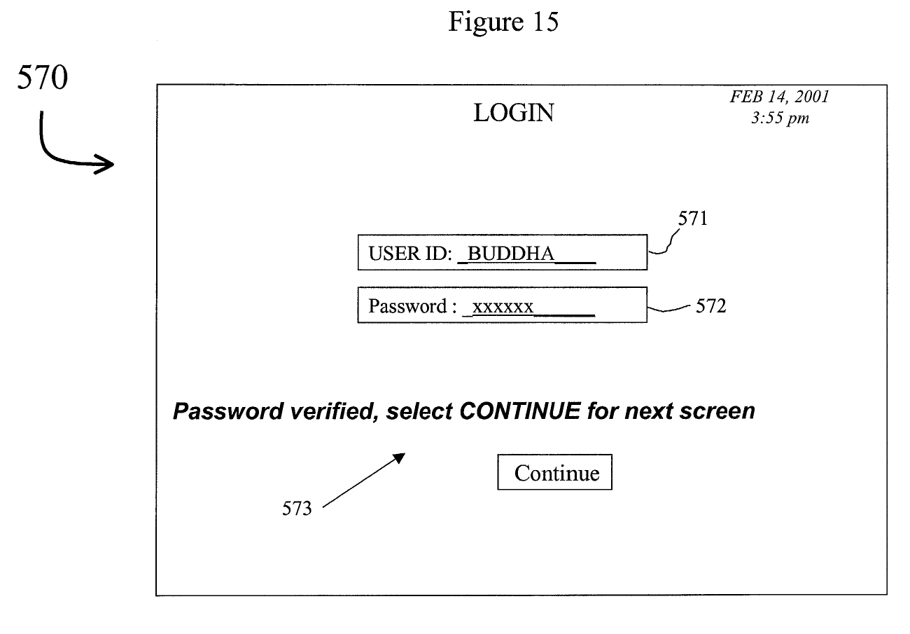

FIG. 15 illustrates a submenu of an exemplary private box arrangement requiring password entry. This feature envisions the case where the DVR TAD 600 has multiple users maintaining their own separate voice mails or private databases of caller information on HDD 320. Preferably, the “LOG-IN to access private voice mail” cell, 530 in TAD menu 500 of FIG. 11 may be optionally set to require a secret code or password to be entered by a user before he/she can access their messages and personal directory.

A user accesses a pass code or password verification screen 570, entitled “LOG IN” for example, from TAD menu 500 by actuating “LOG-IN to access private voice mail” cell, 530. As shown in FIG. 15, the user is prompted for their ID at cell 571 (a last name for example) and a password (cell 572). Once entered, a suitable confirmation or rejection message 573 may be displayed or scrolled beneath the (as shown in FIG. 15, “Password verified, select CONTINUE for next screen” is just one example, this could also be a separate screen display), with the display immediately thereafter shifting back to any of TAD menu 500, Today's Messages submenu 560, or another submenu.

The system default could be set to display the TAD menu 500 again after verification; or alternatively the user can select a desired menu or submenu for the default display after password verification by accessing submenus corresponding to the TAD System Status cell 530 in order to set the desired configuration. Since methods of implementing password protection for voice mail databases and personal messaging are well known in the art, any suitable password protection algorithm or software configuration is acceptable and can be integrated within host processor 310 or accessed from SDRAM 315 by host processor 310.

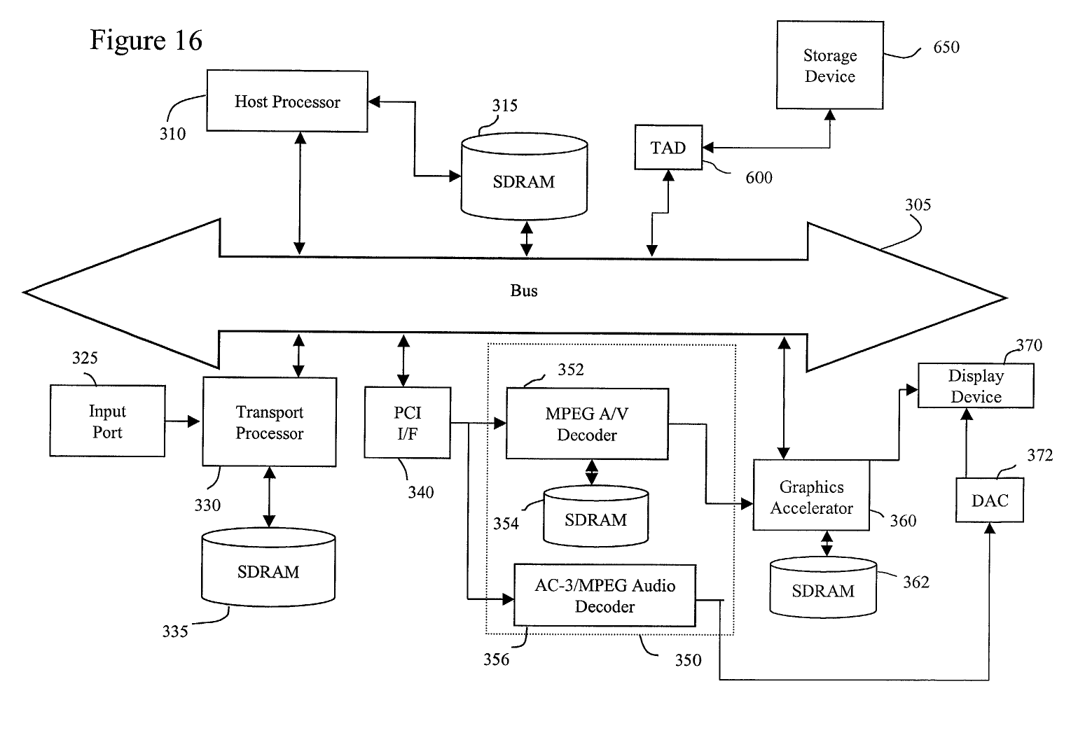

FIG. 16 illustrates an alternate embodiment of a DVR TAD connected to an external mass storage device and the host processor of the STB equipped with DVR in accordance with the invention. The structure and operation of this figure is substantially similar to that of FIG. 3 with the exception that the DVR TAD 600 has its own dedicated mass storage device 650 that is thus external to the STB 300. Similar to FIG. 3, host processor 310 remains the center of operations, but directs all telephone line/network related data received by the TAD 600 to the external storage device 650.

External storage device 650 may be any of known magnetic and/or optical storage devices, (i.e., embodied as RAM, a recordable CD, a flash card, memory stick, etc.). In an exemplary configuration, external storage device 650 may have a capacity of at least several Gbytes, where preferably about at least one (1) Gbyte is available for various DVR TAD 600-dedicated applications. Such a configuration may provide even more storage for the DVR TAD 600 while not burdening the processing capability of STB 300, so that the STB 300 may maximize is storage capacity for its primary purpose of recording and manipulating live programming.

Therefore, the system and method of the present invention provides the ability to maintain a digital telephone answering device on a STB-equipped with DVR utilizing the audio and video features of the STB-equipped with DVR and associated display device(s) connected thereto. The DVR TAD 600 utilizes the same telephone line as the STB-equipped with DVR, and may use memories that are integrated within the STB with DVR architecture, and/or an external mass storage device or memory.

Moreover, the present invention enables a viewer to be provided with a DVR TAD that has enhanced functionality as compared to conventional DTADs, since it utilizes existing hardware and software architecture of a STB equipped with DVR to which it is operatively connected. The DVR TAD 600 is capable of storing an enormous amount of telephone messages as compared to current DTADs. Further, various menu screens associated with DVR TAD 600 features, data or parameters may be displayed and manipulated by the user operating a simple graphical user interface such as a remote control, providing even greater flexibility

The invention being thus described, it will be obvious that the same may be varied in many ways. For example, the functional blocks in FIGS. 3-10 and 14-16 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s).

Additionally, the inventive system may be embodied in a variety of ways; a STB 300 is just one example. Other examples include a personal computer (PC), TV or hardware card that is added to an existing apparatus such as a conventional STB, PC or TV. Still further, the inventive functionality may be downloaded or otherwise programmed into a STB, PC or TV. Moreover, the present invention is not limited to receiving only voice messages, as pager numbers and/or e-mail messages may be received by the DVR TAD 600 via suitable interfaces.

Alternatively in FIGS. 3 and 15, and instead of encoding the digitized audio message via encorder 617 at DVR TAD 600, the analog incoming message may be digitzed into Pulse Coded Modulation (PCM) data without further encoding in DVR TAD 600. In this scenario, digital voice data need not go through the AC-3/MPEG Audio decoder 356. Instead, the PCM data may be directly routed from DVR TAD 600 to DAC 372 for analog conversion prior to display at display device 370.

Further, although the DVR TAD of invention has been described as processing analog voice and/or DTMF signals, it is easily recognized and within the purview of this invention that the system may process pulse signals or pulse tones as well. Such variations are not to be regarded as departure from the spirit and SCOPE of the invention, and all such modifications as would be obvious to one skilled in the art are intended to be included within the scope of the following claims.

What is claimed is:

1. A digital telephone answering device operatively connected to a digital video recorder, comprising
an interface for receiving voice signals and caller ID signals representing a telephone message received from a caller; and
a modem for demodulating the caller ID signals and for digitizing the voice signals to output digital signals to the digital video recorder,
wherein a processor of the digital video recorder directs storage of the received output digital signals to a mass storage device, and controls playback of the stored digital signals of the telephone message to be output at a display device operatively connected to the digital video recorder.

2. The digital telephone answering device of claim 1, wherein the received telephone message is displayed as a text message on the display device.

3. The digital telephone answering device of claim 2, wherein a user sends a command from an interface that is selected from a remote control device or execution keys and buttons provided on the digital video recorder or digital telephone answering device in order to display the text message representing the received phone message, or to emit the received voice message on a speaker of the display.

4. The digital telephone answering device of claim 1, wherein said mass storage device is contained within the digital video recorder and is operatively connected to the digital telephone answering device via a bus, or is external to the digital video recorder and directly connected to the digital telephone answering device.

5. The digital telephone answering device of claim 1, wherein said processor controls display of a telephone answering device main menu for selection of at least one of a plurality of parameters of the digital telephone answering device based on reception of a command to display the telephone answering device main menu by a user.

6. The digital telephone answering device of claim 5, wherein the user manipulates keys of a remote control to transmit commands to said processor to display said telephone answering device main menu on the display device, and further manipulates said remote control to select desired parameters or submenus for display.

7. The digital telephone answering device of claim 5,
wherein one of the parameters is a listing of all telephone messages received on a current day are displayed based on user input, each listing including at least the name of the caller, telephone number and beginning header text of the message, and
wherein the user automatically calls back a desired caller by selecting the caller on the display with a specified key.

8. The digital telephone answering device of claim 5,
wherein one of the parameters is a listing of desired archived telephone messages received during a specified period are displayed based on user input, and
wherein the user automatically calls back a desired caller by selecting the caller on the display with a specified key.

9. The digital telephone answering device of claim 1, wherein the mass storage device is a hard disk drive which stores a directory of caller data that may be accessed by a user, said directory embodied in a menu format on the display for adding, deleting or searching desired caller information.

10. The digital telephone answering device of claim 5,
wherein one of the parameters is a telephone directory of stored caller information that is accessed by a user so as to be displayed in a menu format on the display, and
wherein the user automatically calls back a desired caller by selecting the caller on the display with a specified key.

11. The digital telephone answering device of claim 5,
wherein one of the parameters is a access private box feature that if activated, requires the user to enter a password in order to access received messages corresponding to that user.

12. The digital telephone answering device of claim 1, wherein a user directs the stored digital signals of the telephone message to be sent as a text or sound file to a device that is external to the digital telephone answering device and digital video recorder.

13. The digital telephone answering device of claim 12, wherein the text or sound file is sent by the processor to an external device via a suitable interface.

14. The digital telephone answering device of claim 2, wherein said processor further includes voice recognition engine to convert the stored digital audio signals to video signals for text reproduction on the display device.

15. A method of displaying telephone messages received by a digital telephone answering device using a digital video recorder, comprising:
storing voice signals and caller ID signals representing a telephone message that is received by the digital telephone answering device as digital audio signals and digital caller ID signals in a memory;
processing the stored digital caller ID signals and voice signals under the control of a processor in the digital video recorder; and
outputting, at a display device operatively connected to the digital video recorder, the received telephone message.

16. The method of claim 15, wherein the received telephone message is displayed as a text message on the display device.

17. The method of claim 16, wherein a user sends a command from an interface that is selected from a remote control device or execution keys and buttons provided on the digital video recorder or digital telephone answering device in order to display the text message representing the received phone message, or to emit the received voice message on a speaker of the display device.

18. The method of claim 15, wherein said processing further includes converting the stored digital audio signals to video signals for text reproduction on the display device.

19. In a system having a set top box with a digital telephone answering device connected thereto, an apparatus for displaying phone messages received by the digital telephone answering device on a display device operatively connected to the set top box, comprising:
a memory for storing analog voice signals and caller ID signals representing a telephone voice message received from a caller via a telephone line in digital form; and
a processor for controlling a display of said telephone message based on received commands to access said memory so as to display a text message representation of said received telephone voice message on the display device, or a audio representation of said received telephone voice message on a speaker of the display device.

20. The system of claim 19, wherein said memory and processor are contained within the set top box.

21. The system of claim 19,
wherein said memory is external to the set top box and directly connected to the digital telephone answering device, and
wherein the processor is contained within the set top box.
